(19) United States
(12) Patent Application Publication
(10) Pub. No.: US 2024/0018996 A1
(43) Pub. Date: Jan. 18, 2024

(54) PLAIN BEARING ARRANGEMENT AND NACELLE EQUIPPED WITH A PLAIN BEARING ARRANGEMENT FOR A WIND TURBINE

(71) Applicant: Miba Gleitlager Austria GmbH, Laakirchen (AT)

(72) Inventors: Johannes HOELZL, Berg im Attergau (AT); Albert WALDL, Laakirchen (AT); Patrick LAUBICHLER, Gmunden (AT); Christopher ZEH, Obernfeld (DE)

(73) Assignee: Miba Gleitlager Austria GmbH, Laakirchen (AT)

(21) Appl. No.: 18/038,838

(22) PCT Filed: Nov. 29, 2021
(86) PCT No.: PCT/AT2021/060453

§ 371 Date: May 25, 2023

(30) Foreign Application Priority Data
Nov. 30, 2020 (AT) A51044/2020
Apr. 8, 2021 (AT) A50259/2021
Jul. 15, 2021 (AT) A50580/2021

(51) Int. Cl. F16C 17/12; F16C 43/02

(52) U.S. Cl. CPC F16C 17/12; F16C 43/02; F16C 2360/31; F16C 2226/62; F16C 2226/60

(57) ABSTRACT

A sliding bearing includes an inner ring element; an outer ring element; and at least one sliding bearing element, which is arranged between the inner ring element and the outer ring element, wherein a bearing surface of the sliding bearing pad and a counterface of the outer ring element abut one another, wherein the sliding bearing element includes at least two sliding bearing pads.

The invention relates to a sliding bearing and a nacelle equipped with a sliding bearing for a wind turbine.

A bearing element for bearing the rotor hub of a wind turbine is known from WO 2011/127510 A1.

The object of the present invention was to provide an improved sliding bearing.

This object is achieved by a device according to the claims.

According to the invention, a sliding bearing is formed. The sliding bearing comprises:
an inner ring element;
an outer ring element;
at least one sliding bearing element, which is arranged between the inner ring element and
the outer ring element,
wherein a bearing surface of the sliding bearing element and a counterface of the outer ring element abut one another,
wherein the sliding bearing element comprises at least two sliding bearing pads.

The sliding bearing according to the invention entails the advantage that it has improved sliding properties.

Furthermore, it can be useful if a sliding bearing pad receiving ring is formed which serves for attachment of the sliding bearing pads, wherein the sliding bearing pad receiving ring is held on the inner ring element, wherein in the sliding bearing pad receiving ring, multiple thread holes are formed, which are arranged starting from a first end face of the sliding bearing pad receiving ring in the axial direction of the sliding bearing pad receiving ring and serve to receive fastening screws, wherein through holes are formed in the sliding bearing pads, through which through holes the fastening screws are inserted in order to clamp the sliding bearing pads to the sliding bearing pad receiving ring by means of the fastening screws. This entails the advantage that by this measure, the sliding bearing pads may be coupled to the inner ring element in an easy manner.

It is also possible for the sliding bearing pad receiving ring to have a clearance on an inner jacket surface starting from the first end face of the sliding bearing pad receiving ring. This entails the advantage that the thread holes arranged in the sliding bearing pad receiving ring are not excessively stressed by this measure. This may be necessary in particular if the sliding bearing pad receiving ring is shrunk onto the inner ring element by thermal shrink-fitting and/or is coupled to the inner ring element by means of a press-fit connection. Particularly with such a connection between the sliding bearing pad receiving ring and the inner ring element, stress peaks in the thread holes may be prevented by the clearance. In addition, very high stresses can occur due to bending of the rotor shaft during operation, which can also be reduced by the measures described.

Furthermore, it can be provided that an axial extension of the clearance is between 50% and 180%, in particular between 70% and 140%, preferably between 90% and 110% of a thread depth of the thread holes. In particular, a thus dimensioned clearance can prevent stresses in the thread holes.

An embodiment according to which it may be provided that the sliding bearing pad receiving ring, starting from the first end face of the sliding bearing pad receiving ring, has a plurality of recesses extending in the axial direction, wherein the recesses each are formed between the thread holes, is also advantageous. By the recesses, stress peaks in the thread holes may be prevented. In particular, it may be provided that the recesses are arranged being uniformly distributed over the circumference of the sliding bearing pad receiving ring. In particular, it may be provided that the first end face of the sliding bearing pad receiving ring has a crown shape due to the recesses.

According to an advancement, it is possible that the recesses extend starting from the inner jacket surface of the sliding bearing pad receiving ring to an outer jacket surface of the sliding bearing pad receiving ring and penetrate it. In particular by this, internal stresses in the sliding bearing pad receiving ring may be prevented.

Furthermore, it may be useful if the inner ring element has a taper, wherein the taper is positioned such that the inner jacket surface of the sliding bearing pad receiving ring is spaced from the inner ring element in a first partial section starting from the first end face and the inner jacket surface of the sliding bearing pad receiving ring abuts the inner ring element in a second partial section. By this measure, the occurrence of stress peaks in the thread holes may also be prevented.

In particular, it can be provided that an axial extension of the first partial section is between 50% and 180%, in particular between 70% and 140%, preferably between 90% and 110% of a thread depth of the thread holes.

In an alternative embodiment variant, it may be provided that a sliding bearing pad receiving ring is formed which serves for attachment of the sliding bearing pads, wherein the sliding bearing pad receiving ring is held on the inner ring element, wherein in the sliding bearing pad receiving ring, multiple receiving holes are formed, which are arranged starting from a first end face of the sliding bearing pad receiving ring in the axial direction of the sliding bearing pad receiving ring and serve to receive fastening screws, wherein through holes are formed in the sliding bearing pads, through which through holes the fastening screws are inserted in order to clamp the sliding bearing pads to the sliding bearing pad receiving ring by means of the fastening screws, wherein the fastening screws are inserted through the receiving holes and a fastening element is arranged on a second end face of the sliding bearing pad receiving ring. By the formation of receiving holes in the sliding bearing pad receiving ring and the provision of fastening elements, a surprisingly good connection between the individual sliding bearing pads and the sliding bearing pad receiving ring can be achieved.

Furthermore, it may be provided that a distancing element is arranged between the individual sliding bearing pads, in particular in the circumferential direction, in each case. This entails the advantage that by this measure, the location of the individual sliding bearing pads relative to one another can be predetermined. This entails the advantage that a stressed sliding bearing pad can be supported on the adjacent sliding bearing pad, for example when its twists around the vertical axis of the bearing.

Furthermore, it may be provided that a mechanical rotation prevention is formed which acts in addition to the friction lock provided by the screw connection of the sliding bearing pad to the sliding bearing pad receiving ring.

According to a particular embodiment, it is possible for the distancing element to be adjustable, or for the distancing element to be screwed into the sliding bearing pad, wherein the screw-in depth can be varied. This entails the advantage that by this measure, the spacing of the individual sliding bearing pads in the circumferential direction can be varied and/or adjusted relative to one another.

According to an advantageous advancement, it can be provided that a distancing element is arranged exclusively between two of the sliding bearing pads, wherein the distancing element being is from a selection of standard distancing elements with different sizes. This entails the advantage that when the sliding bearing arrangement is assembled, the individual sliding bearing pads can be inserted and when the last sliding bearing pad is inserted, a suitable distancing element can be selected from the selection of standard distancing elements in order to be able to fix the individual sliding bearing pads relative to one another with respect to the circumferential direction.

In particular, it can be advantageous for the sliding bearing pads to have a toothing on their inner side which corresponds with the inner ring element or with the sliding bearing pad receiving ring. By this measure, it can be achieved that the individual sliding bearing pads are secured against rotation relative to the inner ring element and/or relative to the sliding bearing receiving ring. As an alternative to the toothing, another positive locking connection between the sliding bearing pad and the inner ring element or between the sliding bearing pad and the sliding bearing pad receiving ring may be formed.

Furthermore, it may be provided that a driver element, which corresponds to the sliding bearing pad, is received on the inner ring element or on the sliding bearing pad receiving ring. By this measure, it can be achieved that the individual sliding bearing pads are secured against rotation relative to the inner ring element and/or relative to the sliding bearing receiving ring. As an alternative to the toothing, another positive locking connection between the sliding bearing pad and the inner ring element or between the sliding bearing pad and the sliding bearing pad receiving ring may be formed.

Such a driver element may, for example, be configured in the form of a key. In a first embodiment variant, it may be provided that recesses, which correspond to the driver element, are formed in the sliding bearing pads. In a further embodiment variant, it may be provided that the driver element(s) is positioned such between two adjacent sliding bearing pads that the driver element together with the sliding bearing pads forms a positive locking rotation prevention between the sliding bearing pads and the inner ring element and/or the sliding bearing pad receiving ring.

Furthermore, it may be provided that the thread holes in the sliding bearing pad receiving ring have thread flanks with uncut fibers. This entails the advantage that by this measure an improved solidity of the thread holes can be achieved. This may be achieved in particular by a method of thread forming. In particular, it may be provided that a thread former is used to form the thread. Furthermore, the thread may be produced by thread spinning or by thread rolling.

Furthermore, it may be provided that the individual sliding bearing pads each have a bearing surface that is curved when viewed in the axial direction. In particular, it may be provided that the bearing surface is curved outwardly. In other words, the bearing surface may be convex.

Furthermore, it may be useful if the individual sliding bearing pads in a spherical cap section have the basic shape of a spherical cap with a spherical cap radius.

According to an advancement, it is possible for a removal opening, which starting from a first end face of the outer ring element, interrupts the counterface of the outer ring element, to be formed in the outer ring element which. This entails the advantage that the individual sliding bearing pads can be replaced easily without having to disassemble the complete sliding bearing into its individual parts. In particular, it is conceivable that this measure makes it possible to replace the individual sliding bearing pads in the installed state of the sliding bearing without having to completely disassemble it. Furthermore, it can be provided that the removal opening extends from a first end face of the outer ring element at least to the apex of the sliding bearing element. The individual sliding bearing pads can be easily removed from their operating position through the removal opening.

Furthermore, it may be useful if the removal opening has a circumferential extent and that the sliding bearing pads each have a circumferential extent, wherein the circumferential extent of the sliding bearing pads is between 60% and 99.9%, in particular between 80% and 99%, preferably between 90% and 98% of the circumferential extent of the removal opening. Particularly with such a size ratio, the removal opening has a sufficient circumferential extension to allow the individual sliding bearing pads to be easily removed from the sliding bearing through the removal opening. At the same time, the removal opening is sufficiently small so as not to cause a weakening of the outer ring element and/or a reduction in the load-bearing capacity of the sliding bearing.

In addition, the removal opening can be configured to widen radially towards the first end face. This entails the advantage that the outer ring element may have the highest possible stability and at the same time the sliding bearing pad may be removed as easily as possible through the removal opening.

In addition, it may be provided that the sliding bearing pad receiving ring is shrunk onto the inner ring element. For rotor shafts in particular, this represents an extremely durable and practical connection. During shrink-fitting, the sliding bearing pad receiving ring is heated and/or the inner ring element is cooled to facilitate axial press-fitting. After temperature equalization and thus equalization of the thermal expansions, a tight fit of the sliding bearing pad receiving ring on the inner ring element can be achieved.

In an alternative embodiment variant or in addition, it may be provided that the sliding bearing pad receiving ring is coupled to the inner ring element by means of a material connection, such as a welded connection.

In yet another embodiment variant, it may be provided that the sliding bearing pad receiving ring is coupled to the inner ring element by means of a positive connection, such as a screw connection.

In an advancement, it may be provided that the sliding bearing pads have a shoulder on their inner side, which shoulder rests against an end face of the sliding bearing pad receiving ring, wherein the through holes are arranged in the region of the shoulder. This measure ensures a sufficiently loadable connection between the sliding bearing pads and the inner ring.

In particular, it may be advantageous if a bearing block is formed in which the outer ring element is received, wherein a cover is formed at least on one axial end face of the bearing block, wherein a lubricating oil reservoir is formed integrated in the cover or connected to the cover. This entails the advantage that sufficient lubricating oil for a hydrodynamic sliding bearing can be stored in such a lubricating oil reservoir.

It may also be provided that a thrust ring segment is arranged on a second end face of the sliding bearing pad. This entails the advantage that the spherical cap segment may be configured to absorb the radial forces and/or the axial forces acting in a first direction. The thrust ring segment may be configured to absorb axial forces acting in a second direction. The axial forces acting in the first direction may be greater than the axial forces acting in the second direction. In particular, it may be provided that the thrust ring segment has a sliding surface which interacts with a corresponding counter sliding surface of the outer ring element.

In a first embodiment variant, it may be provided that the thrust ring segment is coupled to the sliding bearing pad by means of fastening means, in particular by means of screws. In particular, it can be provided that the thrust ring segment is coupled to the sliding bearing pad by means of at least two fastening means, preferably by means of three fastening means, in particular by means of Allen screws. The fastening means may be spaced at the same angular distance.

In a further embodiment variant, it may be provided that the thrust ring segment is formed integrally or in one piece with the sliding bearing pad.

It may also be provided that spacers are arranged between the individual sliding bearing pads, as viewed in the circumferential direction. This entails the advantage that the sliding bearing pads may be held in position.

In an advancement, it may be provided that the spacers are arranged directly on the sliding bearing pads. In an alternative embodiment variant, it may be provided that the spacers are configured as independent components that are arranged between the sliding bearing pads.

An embodiment according to which it may be provided that the sliding bearing is formed as a hydrodynamic sliding bearing is also advantageous. Particularly a hydrodynamic sliding bearing has a lower friction resistance and thus a high efficiency.

Furthermore, it is conceivable that a sliding coating is arranged on one of the surfaces of the rotor shaft and/or the bearing block and/or the outer ring element and/or the sliding bearing pads. The sliding coating may be produced by an additive manufacturing process. In particular, it is conceivable that the sliding bearing coating is produced by one of the following processes: metal wire transfer, electron beam welding, friction welding, laser cladding, metal 3D printing, direct energy deposition, binder jetting, material jetting, cold gas spraying, selective laser melting, material extrusion, direct metal laser sintering, direct metal laser melting, cold metal transfer, metal inert gas (MIG) welding, tungsten inert gas (TIG) welding, vat photopolymerization.

It is further conceivable that the sliding coating is produced by a thermal spraying process, such as plasma spraying; flame spraying; wire flame spraying; electric arc spraying; atmospheric plasma spraying; and high velocity flame spraying.

Furthermore, it is conceivable that the sliding coating is produced by one of the following processes: detonation spraying; laser spraying; electroplating; powder coating; electromagnetic pulse welding, electron beam evaporation.

Possible materials for sliding coating are: bronze alloys; aluminum-zinc alloys; white metal; metal matrix composites with dry lubricants and also combinations thereof.

According to the invention, a nacelle for a wind turbine is provided. The nacelle comprises:
a nacelle housing;
a rotor shaft;
a rotor hub, which is arranged on the rotor shaft;
a rotor bearing for bearing the rotor shaft on the nacelle housing. The rotor bearing comprises a sliding bearing formed according to one of the embodiments above.

In particular in nacelles of wind turbines, the sliding bearing according to the invention is advantageous due to its maintainability.

For the purpose of better understanding of the invention, it will be elucidated in more detail by means of the figures below.

These show in a respectively very simplified schematic representation:

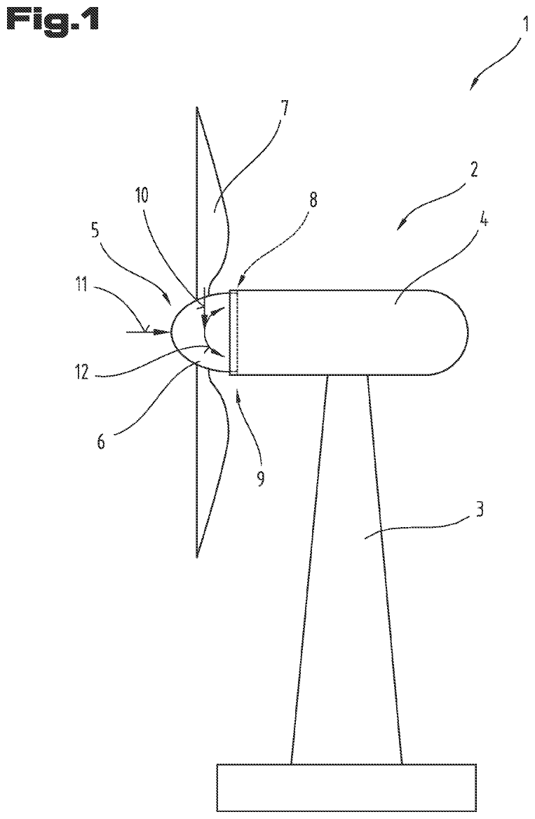

FIG. 1 a schematic representation of a wind turbine;

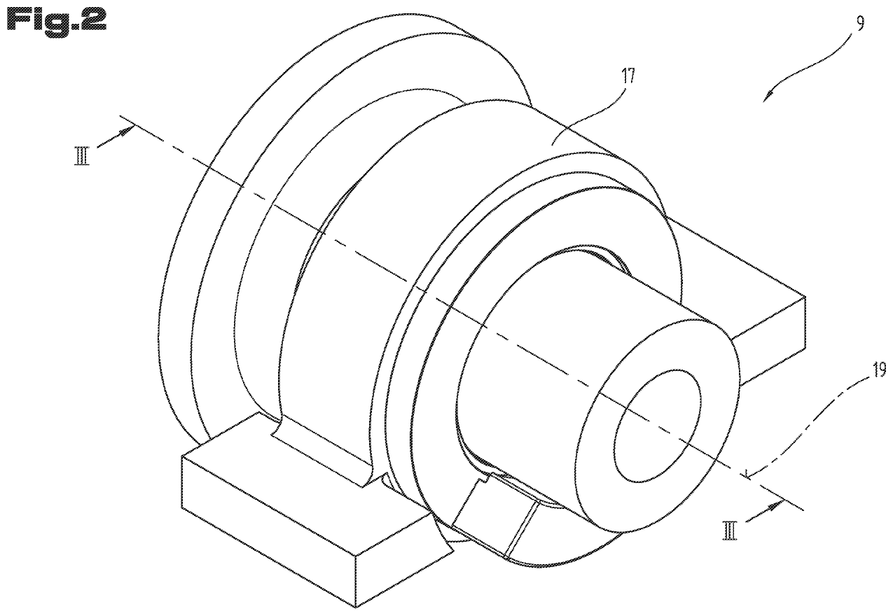

FIG. 2 a perspective representation of a first exemplary embodiment of a sliding bearing;

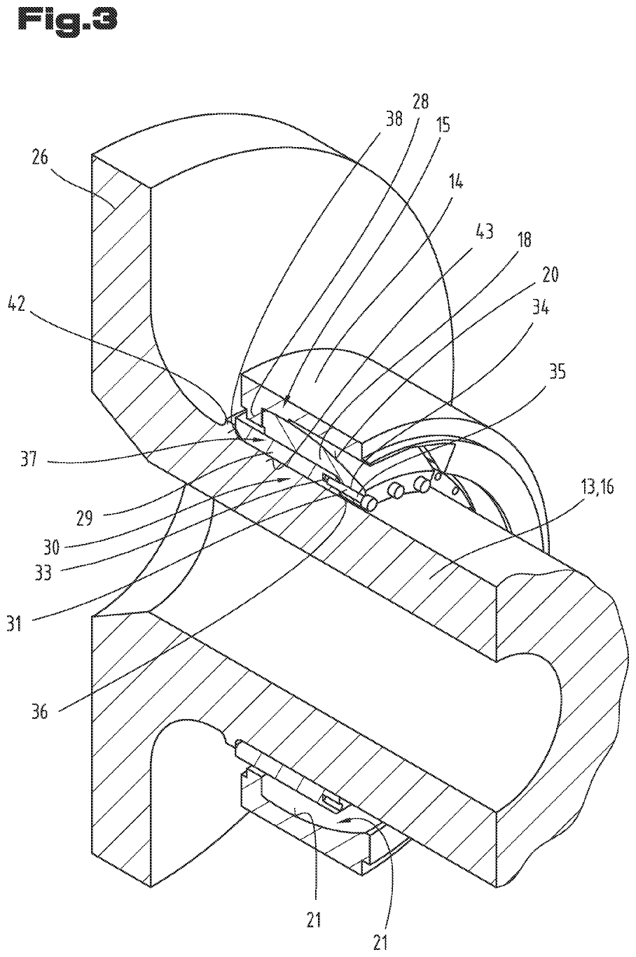

FIG. 3 a perspective sectional view of the first exemplary embodiment of the sliding bearing;

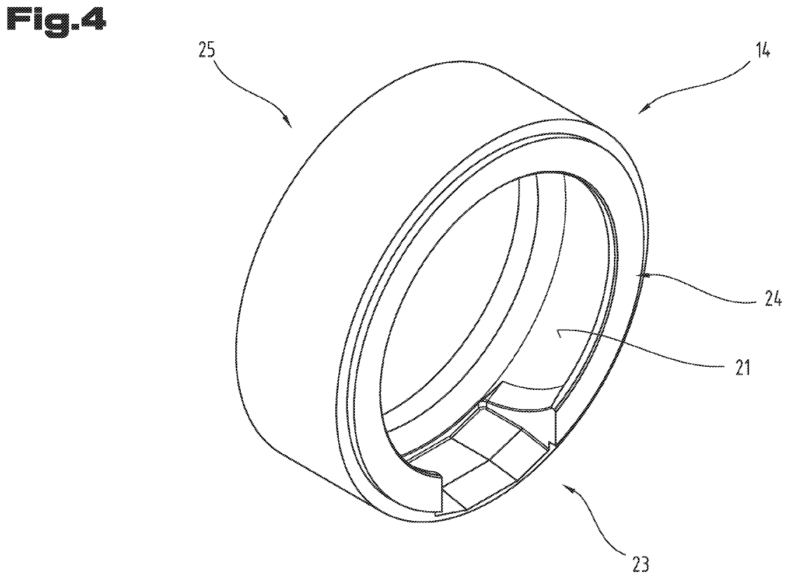

FIG. 4 a schematic representation of an exemplary embodiment of the outer ring;

FIG. 5 a schematic representation of an exemplary embodiment of the sliding bearing pads bearing in a first view;

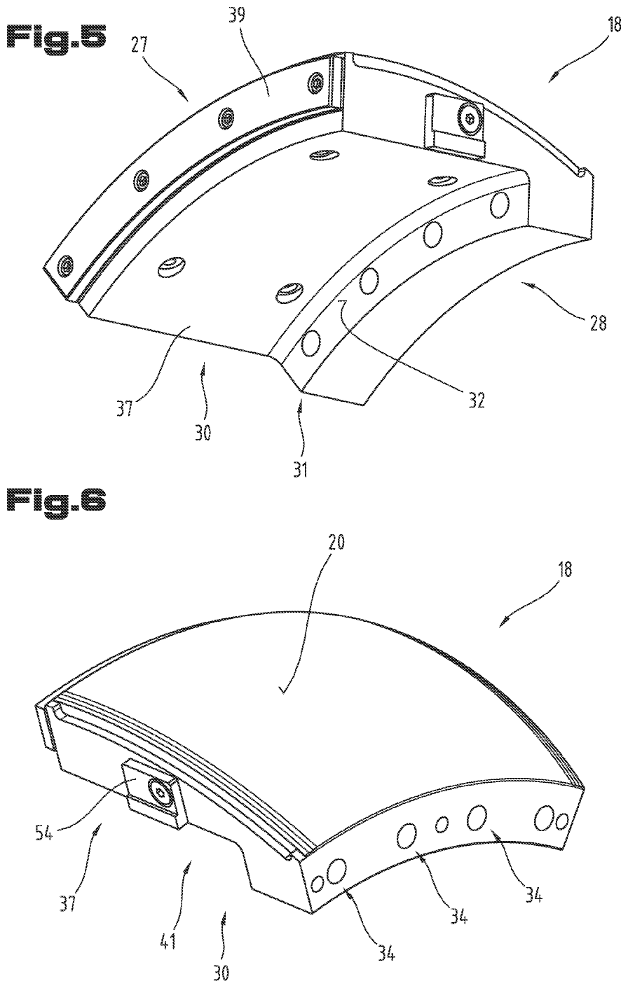

FIG. 6 a schematic representation of an exemplary embodiment of the sliding bearing pads bearing in a second view;

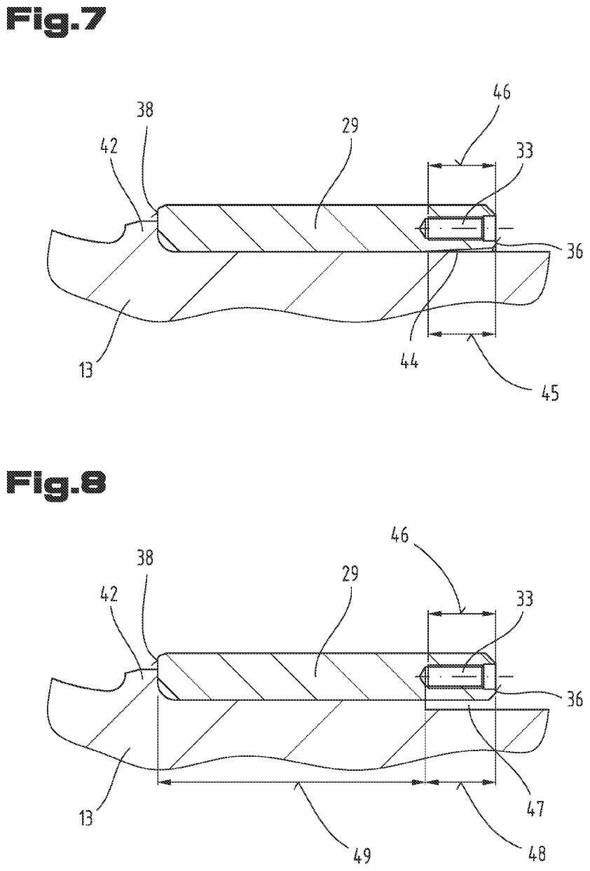

FIG. 7 a sectional view of a first exemplary embodiment of a sliding bearing pad receiving ring;

FIG. 8 a sectional view of a second exemplary embodiment of the sliding bearing pad receiving ring;

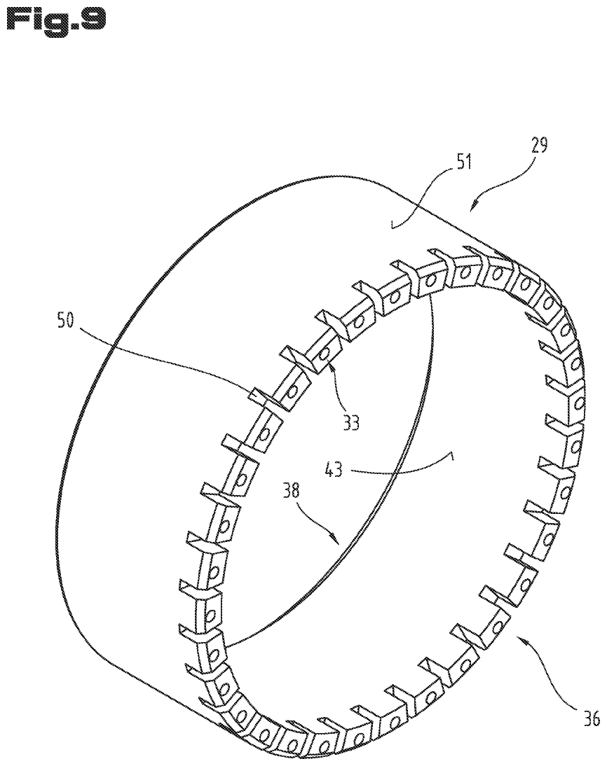

FIG. 9 a sectional view of a third exemplary embodiment of the sliding bearing pad receiving ring;

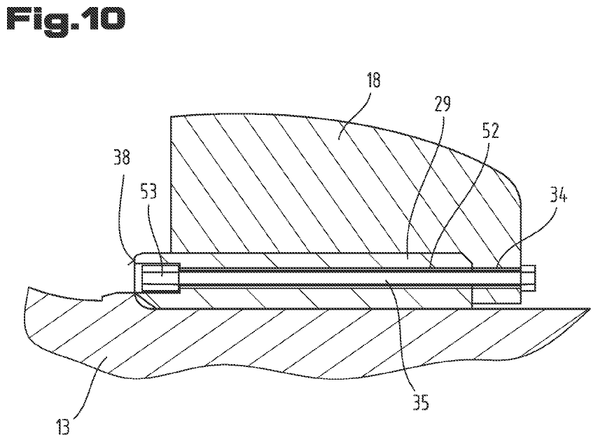

FIG. 10 a sectional view of a fourth exemplary embodiment of the sliding bearing pad receiving ring;

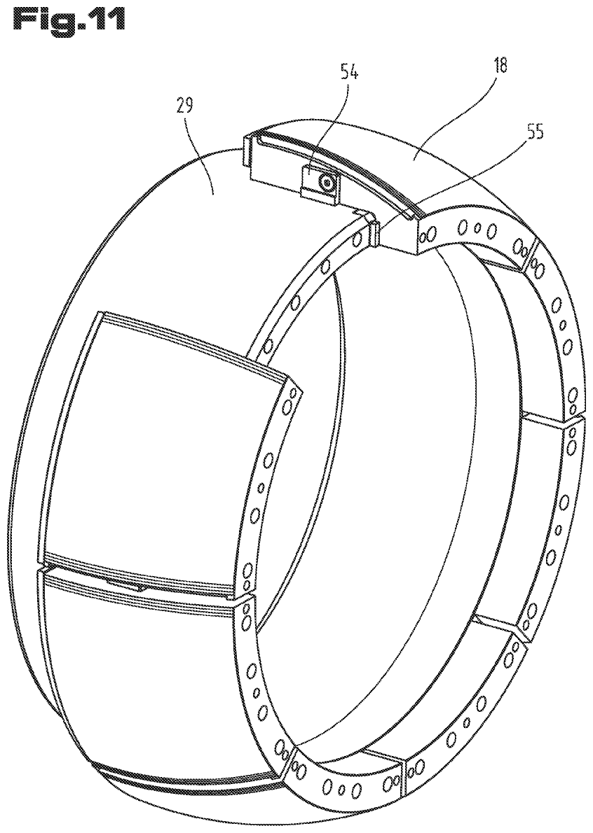

FIG. 11 a perspective representation of the sliding bearing pad receiving ring with sliding bearing pads arranged thereon;

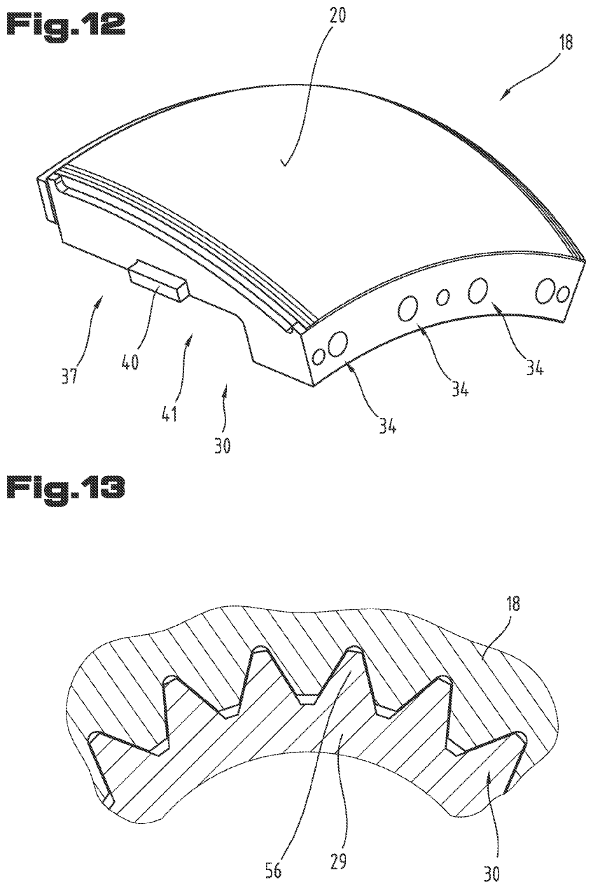

FIG. 12 a further exemplary embodiment of a sliding bearing pad;

FIG. 13 a schematic representation of a positive locking connection between one of the sliding bearing pads.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows, in a schematic view, a first exemplary embodiment of a wind turbine 1 for generating electrical energy from wind energy. The wind turbine 1 comprises a nacelle 2, which is rotatably received on a tower 3. The nacelle 2 comprises a nacelle housing 4, which forms the main structure of the nacelle 2. In the nacelle housing 4 of the nacelle 2, the electrotechnical components such as a generator of the wind turbine 1 are arranged.

Moreover, a rotor 5 is formed, which has a rotor hub 6 with rotor blades 7 arranged thereon. The rotor hub 6 is considered part of the nacelle 2. The rotor hub 6 is received so as to be rotatable on the nacelle housing 4 by means of a rotor bearing 8. In particular, it is provided that a sliding bearing 9 according to the invention and described in more detail below is used as a rotor bearing 8. In particular, it may be provided that the rotor hub 6 is arranged on a rotor shaft 16, wherein the rotor shaft 16 is mounted in the rotor bearing 8.

The rotor bearing 8, which serves for bearing the rotor hub 6 on the nacelle housing 4 of the nacelle 2, is configured for absorbing a radial force 10 and an axial force 11. The axial force 11 is caused by the force of the wind. The radial force 10 is caused by the weight force of the rotor 5 and is effective at the center of gravity of the rotor 5. As the center of gravity of the rotor 5 is outside the rotor bearing 8, a tilting torque 12 is generated in the rotor bearing 8 by the radial force 10. The tilting torque 12 may also be caused by an uneven load of the rotor blades 7. This tilting torque 12 can be absorbed by means of a second bearing, which is arranged at a distance from the rotor bearing 8. The second bearing may, for example, be formed in the region of the generator.

FIG. 2 shows a first exemplary embodiment of the sliding bearing 9 built into the nacelle 2. Of course, the sliding bearing 9 shown in FIG. 2 may also be used in all other industrial applications outside of wind turbines. The sliding bearing 9 is shown in a perspective view in FIG. 2.

FIG. 2 shows the first exemplary embodiment of the sliding bearing 9 in a perspective longitudinal section.

Below, the sliding bearing 9 will be described by means of a combination of FIGS. 2 and 3.

As can be seen from FIGS. 2 and 3, it may be provided that the sliding bearing 9 comprises an inner ring element 13 and an outer ring element 14. Between the inner ring element 13 and the outer ring element 14, a sliding bearing element 15 is arranged, which serves for the rotatory sliding bearing of the inner ring element 13 relative to the outer ring element 14.

In the exemplary embodiment shown in FIGS. 2 and 3, the inner ring element 13 is configured as a rotor shaft 16. Of course, the inner ring element 13 may also be another shaft. Furthermore, it is also conceivable that the inner ring element 13 is formed as a separate component which is received on a shaft, in particular on a rotor shaft 16.

As can particularly well be seen from FIG. 2, it may be provided that the outer ring element 14 is received in a bearing block 17. For the sake of clarity, the bearing block 17 is not shown in FIG. 3.

In particular, it may be provided that the bearing block 17 is coupled to the nacelle housing 4 or, alternatively, is formed directly in the nacelle housing 4. In this exemplary embodiment, it may thus be provided that the outer ring element 14 is rigidly coupled to the nacelle housing 4 and that the inner ring element 13 is rotatable about a rotation axis 19 relative to the outer ring element 14 by means of the sliding bearing element 15.

Furthermore, it may be provided that the bearing block 17 serves directly as the outer ring element 14.

Thus, the rotor shaft 16 is received rotationally in the nacelle housing 4 by means of the sliding bearing 9.

As can further be seen in FIGS. 2 and 3, it may be provided that the sliding bearing element 15 comprises multiple individual sliding bearing pads 18, which are arranged distributed across the circumference, between the inner ring element 13 and the outer ring element 14.

In the operating state of the sliding bearing 9, the individual sliding bearing pads 18 are fixedly coupled to the inner ring element 13 due to the structure shown in FIG. 3 and thus rotate along with it relative to the outer ring element 14. In order to enable the rotational movement between the inner ring element 13 and the outer ring element 14, on each of the individual sliding bearing pads 18 one bearing surface 20 is formed which abuts a counterface 21 of the outer ring element 14 in the operational state of the sliding bearing 9. The counterface 21 is arranged on the inner side 22 of the outer ring element 14.

The bearing surface 20 of the sliding bearing pad 18 and the counterface 21 of the outer ring element 14 are designed as sliding surfaces, which slide on one another during operation of the sliding bearing 9. In particular, it may be provided that the counterface 21 of the outer ring element 14 is configured as a hard, wear-resistant surface, which may be formed, for example, by a hardened steel. The bearing surface 20 of the sliding bearing pad 18 may be formed of a sliding bearing material which is soft in comparison to the counterface 21. Of course, it is also conceivable that the bearing surface 20 has an anti-friction coating.

As can particularly well be seen from FIG. 3, it may be provided that the individual sliding bearing pads 18 each have a bearing surface 20 that is curved as seen in the axial direction. In particular, it may be provided that the bearing surface 20 is formed as a spherical cap.

As can further be seen from FIG. 3, it may be provided that a removal opening 23, which serves for the axial removal of individual ones of the sliding bearing pads 18, is formed in the outer ring element 14.

FIG. 4 shows a perspective view of the outer ring element 14, wherein, again, equal reference numbers and/or component designations are used for equal parts as before in FIGS. 1 to 3. In order to avoid unnecessary repetitions, it is pointed to/reference is made to the detailed description in FIGS. 1 through 3 preceding it.

The removal opening 23 may be seen particularly well in FIG. 4.

As can be seen from FIGS. 3 and 4, it may be provided that the removal opening 23 at least in some sections interrupts the counterface 21 formed in the outer ring element 14. In particular, it may be provided that the removal opening 23 extends starting out from a first end 24 of the outer ring element 14. In particular, it may be provided that the removal opening 23 does not extend up to a second end face 25 of the outer ring element 14.

As can further be seen from FIG. 3, it may be provided that the rotor shaft 16 has a rotor shaft flange 26 which may serve to flange the rotor hub 6.

In FIG. 3, only a single sliding bearing pad 18 is shown for the sake of simplicity, although multiple ones of the sliding bearing pads 18 can be arranged evenly distributed around the circumference.

As can be seen from FIG. 3, it may be provided that a sliding bearing pad receiving ring 29, which serves to receive the individual sliding bearing pads 18, is arranged on the inner ring element 13.

FIGS. 5 and 6 show a detailed view of an embodiment of the sliding bearing pad 18 in various perspective views, wherein again equal reference numbers and/or component designations are used for equal parts as before in FIGS. 1 to 4. In order to avoid unnecessary repetitions, it is pointed to/reference is made to the detailed description in FIGS. 1 through 4 preceding it.

The further structure of the sliding bearing pads 18 and/or the sliding bearing 9 is described by means of the combination of FIGS. 3 to 6.

In particular, it may be provided that the individual sliding bearing pads 18 have a shoulder 31 on an inner side 30. The shoulder 31 can form a contact surface 32 such that the sliding bearing pad 18 can abut against a first end face 36 of the sliding bearing pad receiving ring 29 in the region of the shoulder 31. This allows the sliding bearing pad 18 to be positioned in the axial direction relative to the sliding bearing pad receiving ring 29.

Further, it may be provided that the shoulder 31 defines a recess 37 formed on the inner surface 30 of the sliding bearing pad 18. The recess 37 can extend from the second end face 28 of the sliding bearing pad 18 to the shoulder 31. The recess 37 and/or the shoulder 31 can be rotationally symmetrical, in particular as a rotational segment.

In particular, it may be provided that, in the installed state of the sliding bearing pad 18, the sliding bearing pad receiving ring 29 is at least partially received in the recess 37 of the sliding bearing pad 18.

Furthermore, it can be provided that multiple thread holes 33 are formed on the first end face 36 of the sliding bearing pad receiving ring 29. Corresponding to the thread holes 33, one, in particular multiple, axially extending through holes 34 can be formed on a second end face 28 of the sliding bearing pads 18.

Furthermore, fastening screws 35 can be guided through the through holes 34, which fastening screws 35 can be screwed into the thread holes 33 and thus serve to fasten the sliding bearing pads 18 to the sliding bearing pad receiving ring 29. By means of the fastening screws 35, the sliding bearing pads 18 can be pressed against the sliding bearing pad receiving ring 29 in the axial direction.

As can be seen from FIG. 3, it may be provided that a second end face 38 of the sliding bearing pad receiving ring 29 abuts a shaft bead 42. This allows the sliding bearing pad receiving ring 29 to be positioned axially on the inner ring element 13.

As can be seen particularly well from FIG. 5, it may be provided that a thrust ring segment 39 is arranged on a first end face 27 on the sliding bearing pad 18. The thrust ring segment 39 may serve to absorb axial forces between the sliding bearing pad 18 and the outer ring element 14. In particular, it may be provided that the thrust ring segment 39 has a sliding surface and that the outer ring element 14 has a counter sliding surface, wherein the sliding surface and the counter sliding surface abut one another and slide on one another in operation.

Furthermore, it may be provided that the thrust ring segment 39 is coupled to the second end face 28 of the sliding bearing pad 18 by means of fastening means.

As can further be seen from FIG. 3, it may be provided that the sliding bearing pad receiving ring 29 on its inner jacket surface 43 rests on the inner ring element 13. In particular, it may be provided that the sliding bearing pad receiving ring 29 is coupled to the inner ring element 13 by means of a press fit connection and/or by thermal shrink-fitting.

FIG. 7 shows an exemplary embodiment of the connection between the inner ring element 13 and the sliding bearing pad receiving ring 29 in a sectional view, wherein, again, equal reference numbers and/or component designations are used for equal parts as before in FIGS. 1 to 6. In order to avoid unnecessary repetitions, it is pointed to/reference is made to the detailed description in FIGS. 1 through 6 preceding it.

As can be seen from FIG. 7, it may be provided that a clearance 44 is formed on the sliding bearing pad receiving ring 29 starting out from the first end face 36 of the sliding bearing pad receiving ring 29. The clearance 44 may be formed on the inner jacket surface 43 of the sliding bearing pad receiving ring 29. As can be seen from FIG. 6, the clearance 44 may have an axial extension 45. Furthermore, it may be provided that the thread hole 33 has a thread depth 46.

As can be seen from FIG. 7, it may be provided that the clearance 44 is formed in the shape of a conical expansion.

In an alternative embodiment variant, it may also be provided that the clearance 44 is formed in the shape of a stepping.

FIG. 8 shows a further exemplary embodiment of the connection between the inner ring element 13 and the sliding bearing pad receiving ring 29 in a sectional view, wherein, again, equal reference numbers and/or component designations are used for equal parts as before in FIGS. 1 to 7. In order to avoid unnecessary repetitions, it is pointed to/reference is made to the detailed description in FIGS. 1 through 7 preceding it. The sliding bearing pads 18 received on the sliding bearing pad receiving ring 29 are not shown in FIGS. 7 and 8 for the sake of clarity.

As can be seen from FIG. 8, it may be provided that the inner ring element 13 has a taper 47. In the installed state of the sliding bearing pad receiving ring 29, a first partial section 48 may be formed which extends from the first end face 36 of the sliding bearing pad receiving ring 29, wherein, in the first partial section 48, the inner jacket surface 43 of the sliding bearing pad receiving ring 29 is spaced from the inner ring element 13. In a second partial section 49, the inner jacket surface 43 of the sliding bearing pad receiving ring 29 may abut the inner ring element 13.

FIG. 9 shows, in a sectional view, a further exemplary embodiment of the sliding bearing pad receiving ring 29, wherein, again, equal reference numbers and/or component designations are used for equal parts as before in FIGS. 1 to 8. In order to avoid unnecessary repetitions, it is pointed to/reference is made to the detailed description in FIGS. 1 through 8 preceding it.

As can be seen from FIG. 9, it may be provided that multiple recesses 50 are formed on the first end face 36 of the sliding bearing pad receiving ring 29, which recesses 50 extend from the inner jacket surface 43 of the sliding bearing pad receiving ring 29 to an outer jacket surface 51 of the sliding bearing pad receiving ring 29 and/or penetrate it. As can be seen from FIG. 9, it may be provided that one of the recesses 50 is in each case arranged between two of the thread holes 33.

FIG. 10 shows a further exemplary embodiment of the connection between the inner ring element 13 and the sliding bearing pad receiving ring 29 in a sectional view, wherein, again, equal reference numbers and/or component designations are used for equal parts as before in FIGS. 1 to 9. In order to avoid unnecessary repetitions, it is pointed to/reference is made to the detailed description in FIGS. 1 through 9 preceding it.

As can be seen from FIG. 10, it may be provided that a receiving hole 52, which extends from the first end face 36 of the sliding bearing pad receiving ring 29 to the second end face 38 of the sliding bearing pad receiving ring 29, is formed in the sliding bearing pad receiving ring 29. In particular, it may be provided that a fastening element 53, which cooperates with a fastening screw 35 inserted through the receiving hole 52 and through the through hole 34, is arranged in the region of the second end face 38 of the sliding bearing pad receiving ring 29.

FIG. 11 shows a perspective representation of a further exemplary embodiment of the connection between the sliding bearing pad receiving ring 29 and the sliding bearing pads, wherein, again, equal reference numbers and/or component designations are used for equal parts as before in FIGS. 1 to 10. In order to avoid unnecessary repetitions, it is pointed to/reference is made to the detailed description in FIGS. 1 through 10 preceding it.

As can be seen from FIG. 11, it may be provided that distancing elements 54, which serve for spacing apart the individual sliding bearing pads 18 in the circumferential direction, are arranged between the individual sliding bearing pads 18. The distancing elements 54 may be arranged between two of the sliding bearing pads 18 or between all sliding bearing pads 18. In particular, it may be provided that the distancing elements 54 are in each case coupled to the sliding bearing pad 18 by means of a fastening screw.

As can further be seen from FIG. 11, it may be provided that a driver element 55, which serves for positioning the sliding bearing pads 18 relative to the sliding bearing pad receiving ring 29 in the circumferential direction, is received on the sliding bearing pad receiving ring 29. In particular, it may be provided that the driver element 55 is arranged in the first end face 36 of the sliding bearing pad receiving ring 29.

FIG. 12 shows, in a perspective representation, a further exemplary embodiment of a sliding bearing pad 18, wherein, again, equal reference numbers and/or component designations are used for equal parts as before in FIGS. 1 to 11. In order to avoid unnecessary repetitions, it is pointed to/reference is made to the detailed description in FIGS. 1 through 11 preceding it.

As can be seen from FIG. 12, it may be provided that spacers 40 are formed on the individual sliding bearing pads 18. The spacers 40 may serve for correct spacing of the individual sliding bearing pads 18 to one another in the circumferential direction in place of the distancing elements 54. In particular, it may be provided that the spacers 40 are formed on at least one of the circumferential sides 41 of the sliding bearing pad 18 exclusively in the region of the inner side 30 and do not extend across the entire height of the sliding bearing pads 18. Furthermore, it may be provided that the spacers 40 are formed on both circumferential sides 41 of the sliding bearing pad 18. The spacers 40 may be formed in one piece with the respective sliding bearing pad 18.

FIG. 13 shows a further exemplary embodiment of the connection between the sliding bearing pad receiving ring 29 and the sliding bearing pads 18 in a perspective representation, wherein, again, equal reference numbers and/or component designations are used for equal parts as before in FIGS. 1 to 12. In order to avoid unnecessary repetitions, it is pointed to/reference is made to the detailed description in FIGS. 1 through 12 preceding it.

As can be seen from FIG. 13, it may be provided that the sliding bearing pads 18 have a toothing 56 on their inner side 30, which toothing 56 is coupled to the inner ring element 13 or to the sliding bearing pad receiving ring 29. By the toothing 56, a positive locking connection between the sliding bearing pad 18 and the sliding bearing pad receiving ring 29 or the inner ring element 13 may be established.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Wind turbine |
| 2 | Nacelle |
| 3 | Tower |
| 4 | Nacelle housing |
| 5 | Rotor |
| 6 | Rotor hub |
| 7 | Rotor blade |
| 8 | Rotor bearing |
| 9 | Sliding bearing |
| 10 | Radial force |
| 11 | Axial force |
| 12 | Tilting torque |
| 13 | Inner ring element |
| 14 | Outer ring element |
| 15 | Sliding bearing element |
| 16 | Rotor shaft |
| 17 | Bearing block |
| 18 | Sliding bearing pad |
| 19 | Axis of rotation |
| 20 | Bearing surface |
| 21 | Counterface |
| 22 | Inner side |
| 23 | Removal opening |
| 24 | First end face of outer ring element |
| 25 | Second end face of outer ring element |
| 26 | Rotor shaft flange |
| 27 | First end face |
| 28 | Second end face |
| 29 | Sliding bearing pad receiving ring |
| 30 | Inner side |
| 31 | Shoulder |
| 32 | Contact surface |
| 33 | Thread hole |
| 34 | Through hole |
| 35 | Fastening screw |
| 36 | First end face of sliding bearing pad receiving ring |
| 37 | Recess |
| 38 | Second end face of sliding bearing pad receiving ring |
| 39 | Thrust ring segment |
| 40 | Spacer |
| 41 | Circumferential sides |
| 42 | Shaft bead |
| 43 | Inner jacket surface of sliding bearing pad receiving ring |
| 44 | Clearance |
| 45 | Axial extension of clearance |
| 46 | Thread depth |
| 47 | Taper |
| 48 | First partial section |
| 49 | Second partial section |
| 50 | Recess |
| 51 | Outer jacket surface of sliding bearing pad receiving ring |
| 52 | Receiving hole |
| 53 | Fastening element |
| 54 | Distancing element |
| 55 | Driver element |
| 56 | Toothing |

1. A sliding bearing (9) comprising:
an inner ring element (13);
an outer ring element (14); and
at least one sliding bearing element (15), which is arranged between the inner ring element (13) and the outer ring element (14),
wherein a bearing surface (20) of the sliding bearing pad (18) and a counterface (21) of the outer ring element (14) abut one another, and
wherein the sliding bearing element (15) comprises at least two sliding bearing pads (18).

2. The sliding bearing (9) according to claim 1, wherein a sliding bearing pad receiving ring (29) is formed which serves for attachment of the sliding bearing pads (18), wherein the sliding bearing pad receiving ring (29) is held on the inner ring element (13), wherein in the sliding bearing pad receiving ring (29), multiple thread holes (33) are formed, which are arranged starting from a first end face (36) of the sliding bearing pad receiving ring (29) in the axial direction of the sliding bearing pad receiving ring (29) and serve to receive fastening screws (35), wherein through holes (34) are formed in the sliding bearing pads (18), through which through holes (34) the fastening screws (35) are inserted in order to clamp the sliding bearing pads (18) to the sliding bearing pad receiving ring (29) by means of the fastening screws (35).

3. The sliding bearing (9) according to claim 2, wherein the sliding bearing pad receiving ring (29) has a clearance (44) on an inner jacket surface (43) starting from the first end face (36) of the sliding bearing pad receiving ring (29).

4. The sliding bearing (9) according to claim 3, wherein an axial extension (45) of the clearance (44) amounts to between 50% and 180%, in particular between 70% and 140%, preferably between 90% and 110% of a thread depth (46) of the thread holes (33).

5. The sliding bearing (9) according to claim 2, wherein the sliding bearing pad receiving ring (29), starting from the first end face (36) of the sliding bearing pad receiving ring (29), has a plurality of recesses (50) extending in the axial direction, wherein the recesses (50) each are formed between the thread holes (33).

6. The sliding bearing (9) according to claim 5, wherein the recesses (50) extend starting from the inner jacket surface (43) of the sliding bearing pad receiving ring (29) to an outer jacket surface (51) of the sliding bearing pad receiving ring (29) and penetrate it.

7. The sliding bearing (9) according to claim 2, wherein the inner ring element (13) has a taper (47), wherein the taper (47) is positioned such that the inner jacket surface (43) of the sliding bearing pad receiving ring (29) is spaced from the inner ring element (13) in a first partial section (48) starting from the first end face (36) and the inner jacket surface (43) of the sliding bearing pad receiving ring (29) abuts the inner ring element (13) in a second partial section (49).

8. The sliding bearing (9) according to claim 1, wherein a sliding bearing pad receiving ring (29) is formed which serves for attachment of the sliding bearing pads (18), wherein the sliding bearing pad receiving ring (29) is held on the inner ring element (13), wherein in the sliding bearing pad receiving ring (29), multiple receiving holes (52) are formed, which are arranged starting from a first end face (36) of the sliding bearing pad receiving ring (29) in the axial direction of the sliding bearing pad receiving ring (29) and serve to receive fastening screws (35), wherein through holes (34) are formed in the sliding bearing pads (18), through which through holes (34) the fastening screws (35) are inserted in order to clamp the sliding bearing pads (18) to the sliding bearing pad receiving ring (29) by means of the fastening screws (35), wherein the fastening screws (35) are inserted through receiving holes (52) and a fastening element (53) is arranged on a second end face (38) of the sliding bearing pad receiving ring (29).

9. The sliding bearing (9) according to claim 1, wherein a distancing element (54) is in each case arranged between the individual sliding bearing pads (18).

10. The sliding bearing (9) according to claim 9, wherein the distancing element (54) is configured to be adjustable, or that wherein the distancing element (54) is screwed into the sliding bearing pad (18), wherein the screw-in depth is variable.

11. The sliding bearing (9) according to claim 1, wherein a distancing element (54) is arranged exclusively between two of the sliding bearing pads (18), wherein the distancing element (54) is selected from a selection of standard distancing elements with different sizes.

12. The sliding bearing (9) according to claim 1, wherein the sliding bearing pads (18) have a toothing (56), which corresponds with the inner ring element (13) or with the sliding bearing pad receiving ring (29), on their inner side (30).

13. The sliding bearing (9) according to claim 1, wherein a driver element (55), which corresponds to the sliding bearing pad (18), is received on the inner ring element (13) or on the sliding bearing pad receiving ring (29).

14. The sliding bearing (9) according to claim 2, wherein the thread holes (33) in the sliding bearing pad receiving ring (29) have thread flanks with uncut fibers.

15. A nacelle (2) for a wind turbine (1), the nacelle (2) comprising:
a nacelle housing (4);
a rotor shaft (16);
a rotor hub (6) which is arranged on the rotor shaft (16); and
a rotor bearing (8) for bearing the rotor shaft (16) on the nacelle housing (4),
wherein the rotor bearing (8) comprises the sliding bearing (9) according to claim 1.
